(19) United States
(12) Patent Application Publication
(10) Pub. No.: US 2002/0070563 A1
(43) Pub. Date: Jun. 13, 2002

(54) Side panel latch

(76) Inventor: Fabrice Vitry, Worcester (GB)

Correspondence Address: Paul & Paul, 2900 Two Thousand Market Street, Philadelphia, PA, 19103, US

(21) Appl. No.: 09/975,447

(22) Filed: Oct. 11, 2001

Related U.S. Application Data
(60) Provisional application No. 60/239,650, filed on Oct. 12, 2000.

(51) Int. Cl. E05C 1/10

(52) U.S. Cl. 292/175

(57) ABSTRACT

A side panel slam action latch comprising a two-piece assembly embodied in a rigid housing and a relatively flexible pawl member. The flexible portion of the pawl serving to actuate the pawl from a closed position to an open position. Locking pegs extend from the pawl to lock the latch, and upon actuation of the pawl, the locking pegs retract and allow for opening and closing of the door panel, which houses the latch.

### CROSS REFERENCE TO RELATED APPLICATIONS

This application claims the benefit of U.S. Provisional Application No. 60/239,650 filed Oct. 12, 2000.

### BACKGROUND OF THE INVENTION

1. Field of the Invention

The present invention relates generally to latching devices, and more particularly to a side panel slam-to-close latching system for latching hinged doors or panels and the like to a corresponding frame for various uses, such as in vehicles.

2. Brief Description of the Prior Art

Door-mounted “slam” latches employ a camming surface on the end of a sliding-bolt element that cooperates with a striker on the door frame to cause a bolt action to secure the door when it is closed against the frame. Such latches are activated to secure the door when the door is merely pushed shut or slammed. However, to open the door, operation of the latch mechanism is required to release the latch. In some slam latches, as the door is being closed, the bolt is urged against a spring force by the action of a camming surface cooperating with the striker to slide into the latch housing. Once the camming surface has passed the door frame inner surface, the spring force then urges the bolt element to engage behind the door frame, or to engage a keeper mounted on the door frame. In order to open the door, the bolt is manually operated, usually through a grip, to withdraw the bolt from engagement with the keeper.

Examples of prior art slam latches are disclosed in U.S. Pat. Nos. 3,841,674, 3,850,464, 5,482,333 and 5,628,634.

The spring force for such latches can be provided through separate spring elements, such as a torsion bar spring (FIGS. 8-9, U.S. Pat. No. 3,841,674), a torsion coil spring (FIGS. 11-13, U.S. Pat. No. 3,841,674), or a compression coil spring (FIG. 13, U.S. Pat. No. 3,841,674). Alternatively, the spring element can be integrally molded with a latch body made from an appropriate plastic or polymeric material (FIGS. 1-7, U.S. Pat. No. 3,841,674; U.S. Pat. No. 5,842,333; FIG. 6A-6E, U.S. Pat. No. 5,628,534).

Slam latches with integrally molded spring elements have a number of advantages over slam latches that use separate metal springs. First, slam latches with integrally molded spring elements tend to be less expensive because fewer parts are required to be made and assembled for each latch. Further, during manufacture metal springs may become embrittled and thus subject to breakage.

On the other hand, prior art latches with integrally molded spring elements may not have the same life expectancy as those that use separate metal springs. Elements formed from polymeric materials that are subjected to cyclic stresses, such as integrally molded spring elements in slam latches, sometimes fail at stress levels far below their yield stress, due to fatigue failure.

Prior slam latches have employed generally planar integrally molded spring elements. Examples include those shown in FIGS. 1-7 of U.S. Pat. No. 3,850,464, and FIGS. 6B-6E of U.S. Pat. No. 5,628,534. A variation is disclosed in U.S. Pat. No. 5,482,333, in which the spring member 5 includes two pairs of integrally hinged generally planar elements, molded from a suitable resin, such as polypropylene, in a relaxed configuration. In each of these designs, when the latch is operated stresses are generated primarily proximate the portion of the latch where the spring extends from the latch body.

There is a need for a simple, inexpensive slam latch having an integrally molded spring element that resists cyclic stresses and fatigue failure, and which can be easily and inexpensively manufactured with minimal parts, and which is user friendly.

### SUMMARY OF THE INVENTION

The present invention provides a latch of the slam type for installation in an opening in a door or panel for releasably retaining the panel relative to a frame. The latch is particularly useful for securing carpeted panels, such as are found in automotive interiors.

The latch is adapted for installation in a generally rectangular opening or aperture formed in the panel near the edge of the door panel.

The latch includes a generally flat, rectangular upper plate, which is positioned above the door panel when the latch is mounted in the opening. In a presently preferred embodiment, the plate extends beyond the edge of the door panel and over the top of the frame, thereby serving to prevent inward movement of the door panel beneath the frame.

The latch also includes a generally box-like latch housing that extends and is molded directly under the plate and through the opening in the door panel when the latch is mounted in the door panel. The latch housing forms a central well, and the well extends through a generally rectangular central opening that is formed in the plate. The central well is divided into a pawl recess and an actuation recess, whereby a housing wall separates the pawl recess from the actuation recess.

The latch is a two-piece assembly comprising a pawl and a housing. The pawl is assembled within the housing, and snaps together. The pawl includes a living spring portion, which flexibly moves the locking portion of the pawl into and out of locking position under the frame.

The latch is operated in the following manner: the operator squeezes the pawl against the housing wall, using two fingers, one against the pawl and the other against the backside of the housing wall. As a result of the squeezing action, the pawl living spring flexes and the pawl moves away from the frame. When the pawl exits the frame completely the latch is unlocked and the operator can pull the latch and the panel will open. The pawl provides for a slam action by the use of a ramp shape, which interacts with the frame, which forces the pawl away from the frame and forces the pawl living spring to flex. After the latch has cleared the frame the pawl living spring relaxes and the pawl engages the frame, completing the latching process.

The latch is installed into the door panel by snapping. The lower part of the housing is placed into a hole provided for this purpose, while leaving the upper part of the housing (a flange or upper lip) above the surface of the panel.

It is an object of the present invention to provide a latch, which is useful for securing a door panel such as a door panel in a vehicle.

It is another object of the present invention to provide a latch, which includes a living spring member, which allows for the latch o return to its original position once it is released.

Still another object of the present invention is to provide a latch, which is easily mounted in the door or panel frame and can easily accommodate the door or panel.

Another object of the present invention is to provide a latch, which is designed relatively simply and inexpensive, yet can perform its function properly.

Yet another object of the present invention is to provide a latch, which comprises a minimum number of parts.

It is still another object of the present invention to provide a latch, which comprises two separate pieces, which snap-fit together for assembly.

### BRIEF DESCRIPTION OF THE DRAWINGS

FIG. 1 is a perspective view of the side panel latch shown in the neutral position according to the present invention.

FIG. 2 is a top view of the side panel latch of FIG. 1 shown in the neutral position.

FIG. 3 is a bottom view of the side panel latch of FIG. 1 shown in the neutral position.

FIG. 4 is a perspective view of the side panel latch shown in the actuated position according to the present invention.

FIG. 5 is a top view of the side panel latch of FIG. 4 shown in the actuated position.

FIG. 6 is a bottom view of the side panel latch of FIG. 4 shown in the actuated position.

FIG. 7 is a perspective view of the pawl according to the present invention.

FIG. 8 is a top view of the pawl of FIG. 7.

FIG. 9 is a bottom view of the pawl of FIG. 7.

FIG. 10 is a perspective view of the housing according to the present invention.

FIG. 11 is a top view of the housing of FIG. 10.

FIG. 12 is a bottom view of the housing of FIG. 10.

FIG. 13 is a top view of the side panel latch installed in an assembly shown in the neutral position with the door or panel portion closed according to the present invention.

FIG. 14 is a bottom view of the side panel latch of FIG. 13 installed in an assembly shown in the neutral position.

FIG. 15 is a cross-sectional side elevation view of the side panel latch of FIG. 13 installed in an assembly shown in the neutral position.

FIG. 16 is a magnified view of the cross-sectional side elevation view of the side panel latch of FIG. 15 installed in an assembly shown in the neutral position.

FIG. 17 is an alternate cross-sectional perspective view of the side panel latch of FIG. 13 installed in an assembly shown in the neutral position.

FIG. 18 is a cross-sectional side elevation view of the side panel latch installed in an assembly shown in the actuated position.

FIG. 19 is a magnified view of the cross-sectional side elevation view of the side panel latch of FIG. 18 installed in an assembly shown in the actuated position.

FIG. 20 is a cross-sectional perspective view of the side panel latch installed in an assembly shown in the actuated position with the door or panel portion open.

FIG. 21 is an isolated cross-sectional perspective view of the side panel latch installed in an assembly shown in the actuated position.

FIG. 22 is a cross-sectional side elevation view of the side panel latch of FIG. 20 installed in an assembly shown in the actuated position with the door or panel portion open.

FIG. 23 is a magnified cross-sectional side elevation view of the side panel latch of FIG. 22 installed in an assembly shown in the actuated position with the door or panel portion open.

### DETAILED DESCRIPTION OF THE PREFERRED EMBODIMENTS

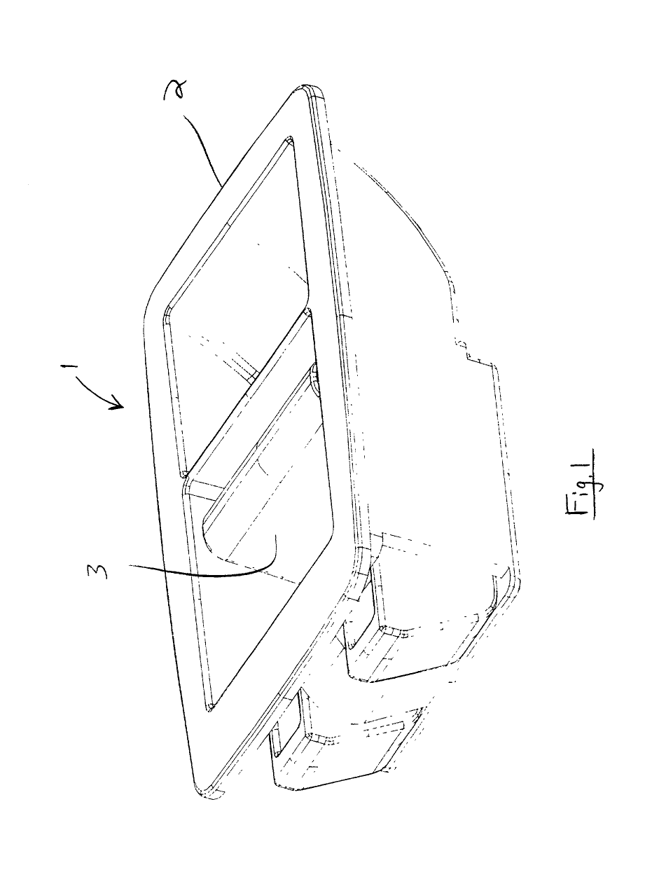

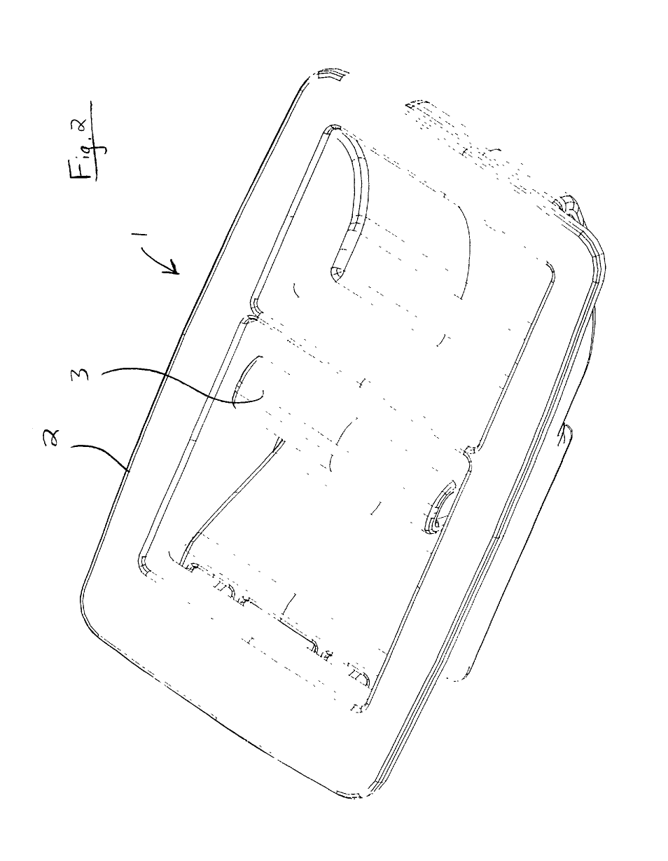

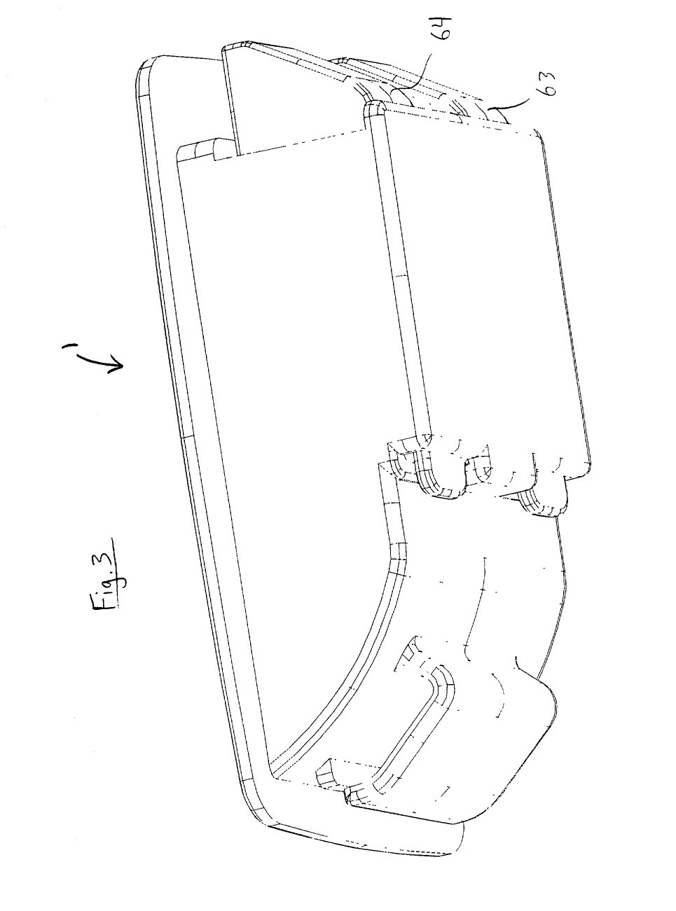

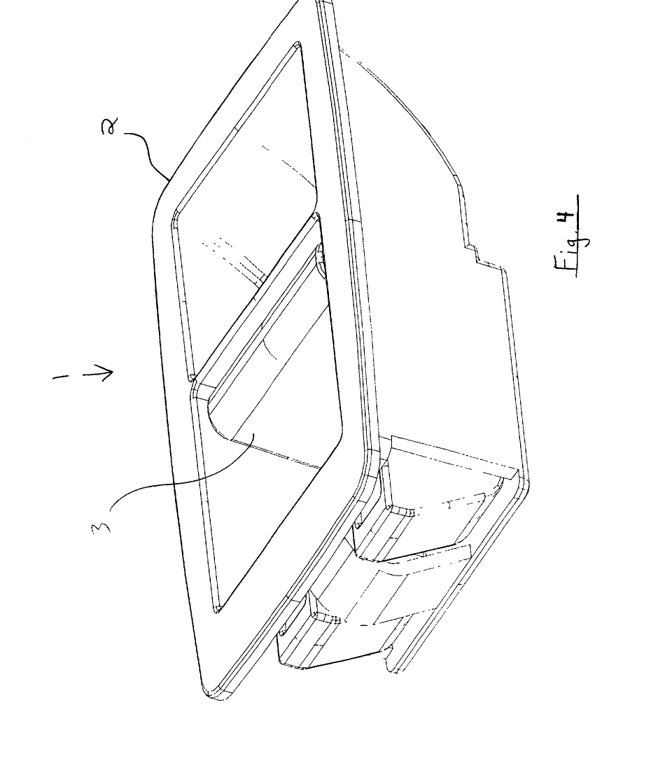

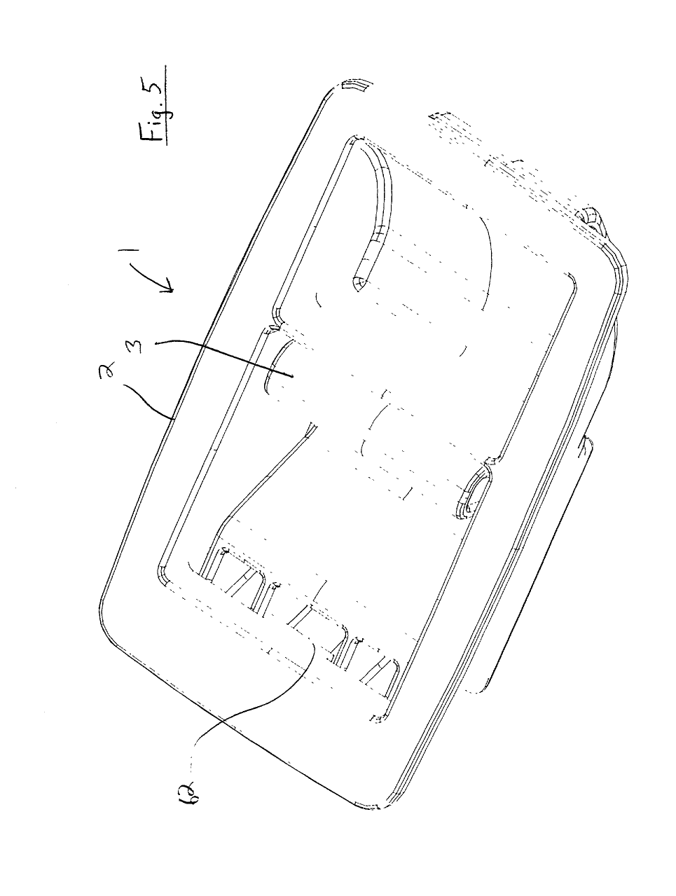

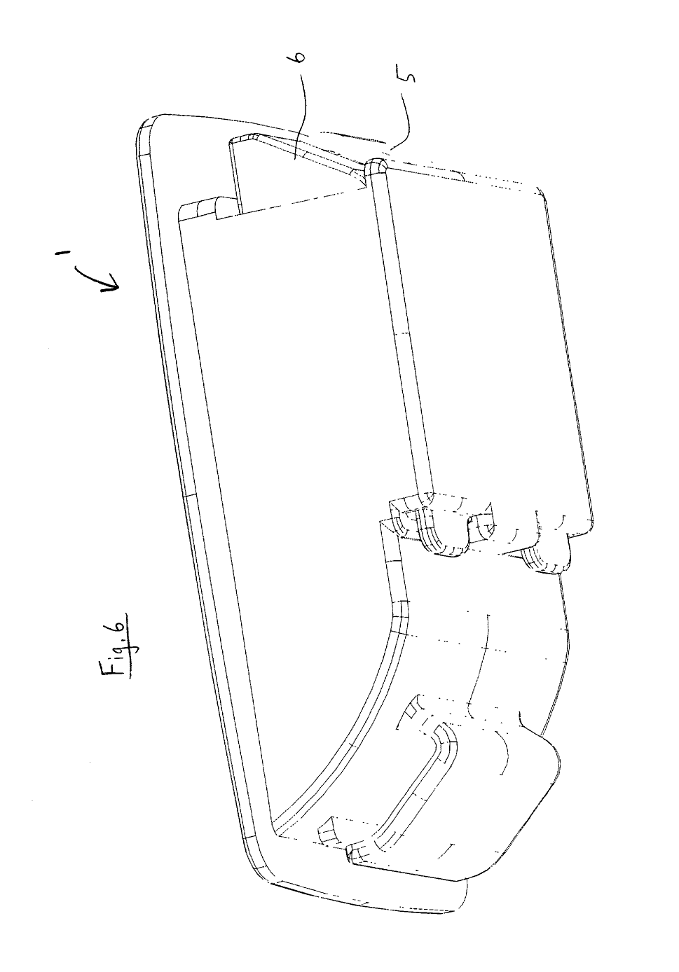

Referring now to the drawings in detail, wherein like reference numerals indicate like elements throughout the several views, there is shown in FIGS. 1-6 various views of a side panel latch according to the present invention. The latch 1 comprises two separate parts, a housing 2 and a pawl 3, each of which is a separately molded piece.

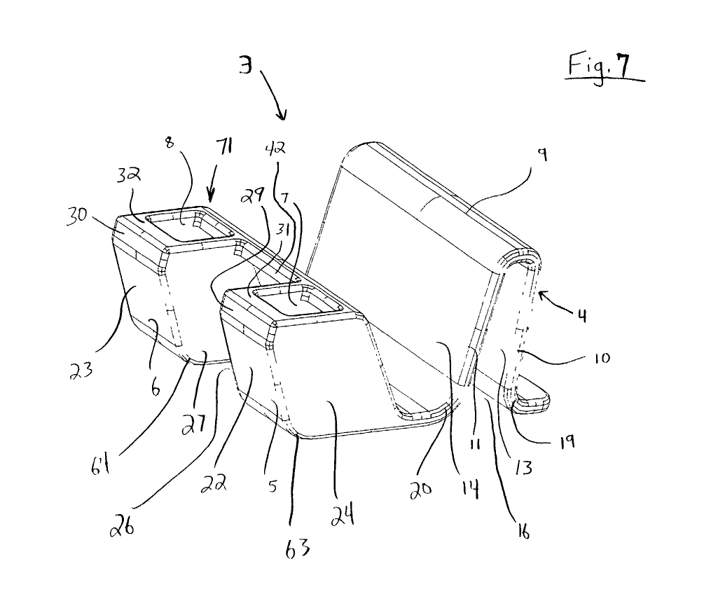

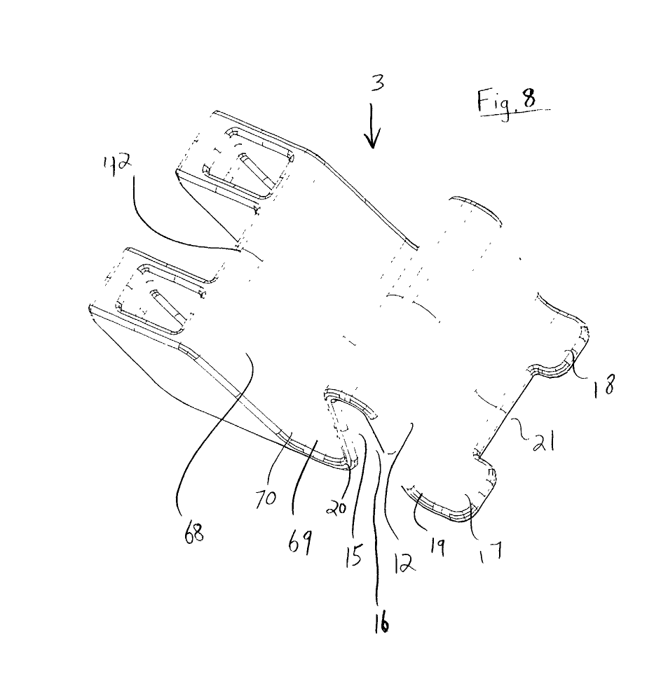

Reference now will be made to the individual components of the latch 1. FIGS. 7-9 show various views of the pawl 3 of the latch 1. Wherein said pawl 3 comprises a locking portion 71, and a living spring portion 4, wherein said living portion 4 is embodied in a generally inverted U-shaped mechanism. Said pawl 3 further comprises a pair of locking pegs 5, 6 for retaining the latch 1 in a closed position. Said locking peg 5 comprises an indentation 7 recessed on the top wall 31 of locking peg 5. Similarly, said locking peg 6 comprises an indentation 8 recessed on the top wall 32 of locking peg 6. Said locking peg 5 further comprises a front ramped wall 22, a curved bottom peg portion 63, a front straight upper wall 29, outer side wall 24, inner side wall 28, and bottom wall 33. Moreover, said locking peg 6 also further comprises a front ramped wall 23, a curved bottom peg portion 64, a front straight upper wall 30, outer side wall 25, inner side wall 27, and bottom wall 34.

Said locking pegs 5, 6 are separated from each other by a space 26, wherein said space 26 terminates at a sloped inner wall 41, wherein a straight upper lip 42 extends upwardly from said sloped inner wall 41. A sloped outer wall 68 is the opposite side of sloped inner wall 41, wherein said sloped outer wall 68 joins said locking pegs 5, 6 to the living spring portion 4 of the pawl 3.

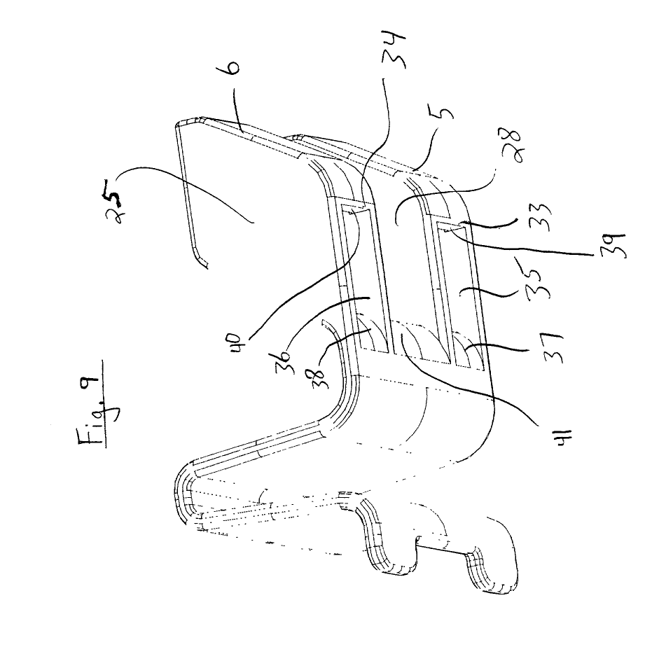

As best seen in FIG. 9, the bottom wall 33 of locking peg 5 comprises an indentation 35, wherein said indentation 35 comprises a sloped back wall 37, which is angled at the same position and at the same plane as sloped inner wall 41. Diametrically opposed to said sloped back wall 37 is front wall 39 of indentation 35. Similarly, the bottom wall 34 of locking peg 6 comprises an indentation 36, wherein said indentation 35 comprises a sloped back wall 38, which is angled at the same position and at the same plane as sloped inner wall 41. Diametrically opposed to said sloped back wall 38 is front wall 40 of indentation 36.

Said living spring portion 4 of said pawl 3 further comprises a curvilinear flexion portion 9 located at a position atop of said living spring portion 4. Said living spring portion 4 further comprises a pair of generally downward sloping walls 10, 11 extending downwardly from said curvilinear flexion portion 9. Whereby, generally downward sloping wall 11 is diametrically opposed to sloped outer wall 68. Generally downward sloping wall 10 comprises an outer wall 12, an inner wall 13, and a curved portion 19. Whereas, generally downward sloping wall 11 comprises an outer wall 14, an inner wall 15, and a curved portion 20. An open space 16 separates said downward sloping wall 10 from downward sloping wall 11. A pair of catches 17, 18 extend from said curved portion 19 of said living spring portion 4, wherein a catch indent separates said catch 17 from said catch 18.

Said curved portion 20 of said living spring portion 4 terminates at a pawl base 69, which joins said living spring portion 4 with said locking portion 71. Said sloped outer wall 68 terminates at a curved joining portion 70, which terminates at said pawl base 69, thus joining said locking portion 71 with said living spring portion 4.

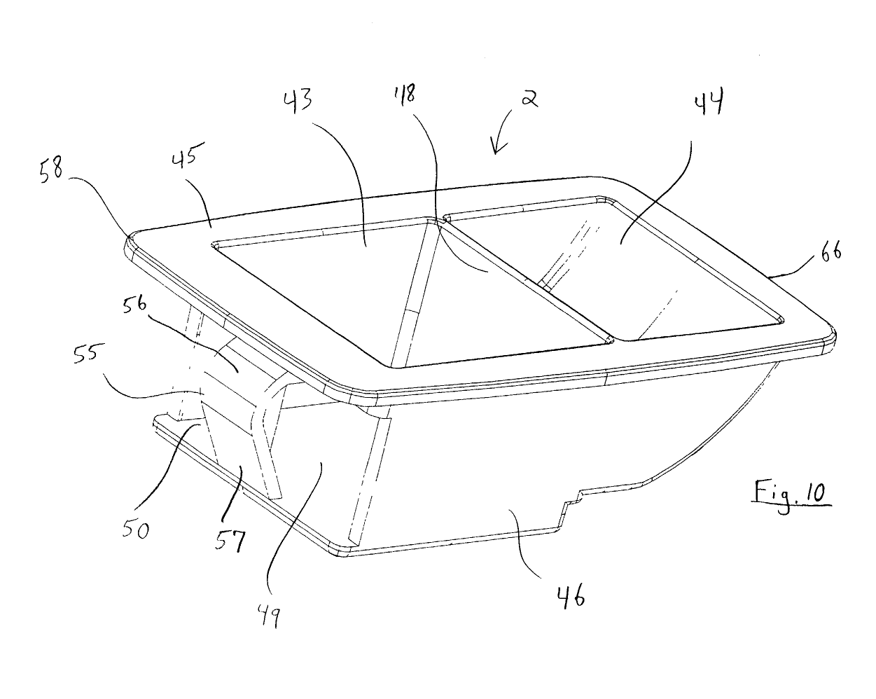

FIGS. 10-12 show various views of the housing 2 of the latch 1. The housing 2 comprises a pawl recess 43, an actuation recess 44, a top surface 45, a front upper lip 58, a rear upper lip 66 a right side wall 46, a left side wall 47, a housing wall 48, a pair of peg opening holes 49, 50, a pair of catch opening holes 51, 52, a base 53, a curved base 61, a rear catch 54, a front catch 55, a stop 62, a guide 67, and a catch stop 65.

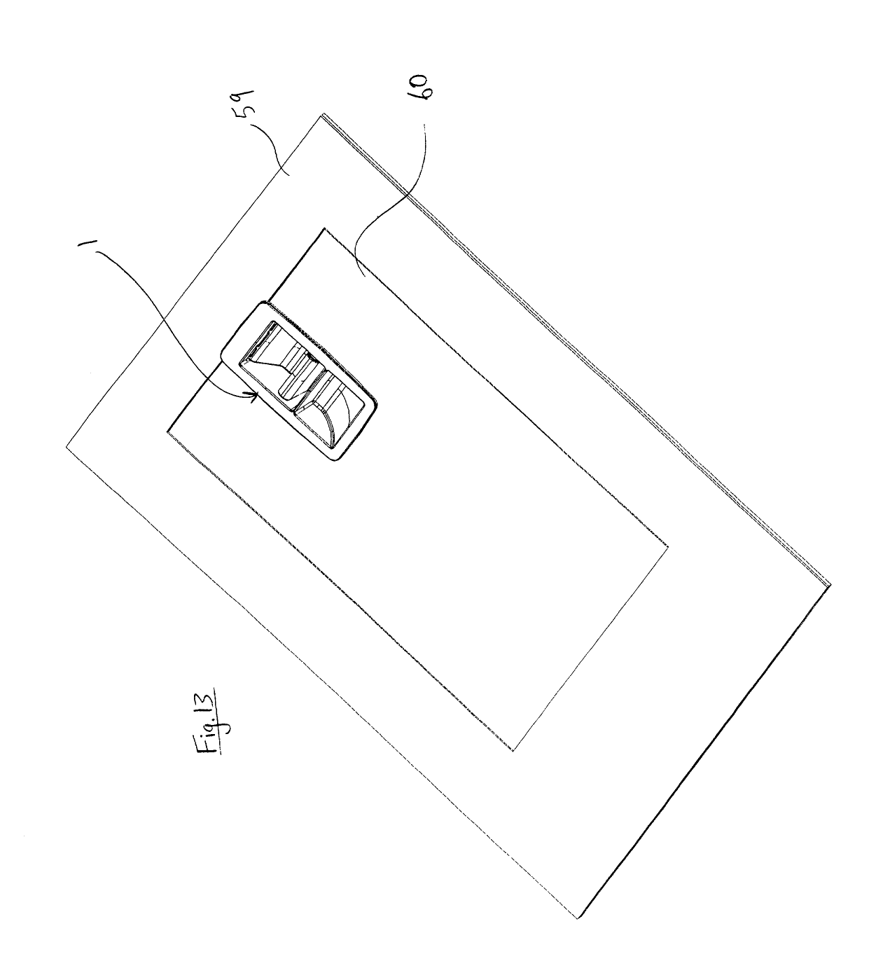

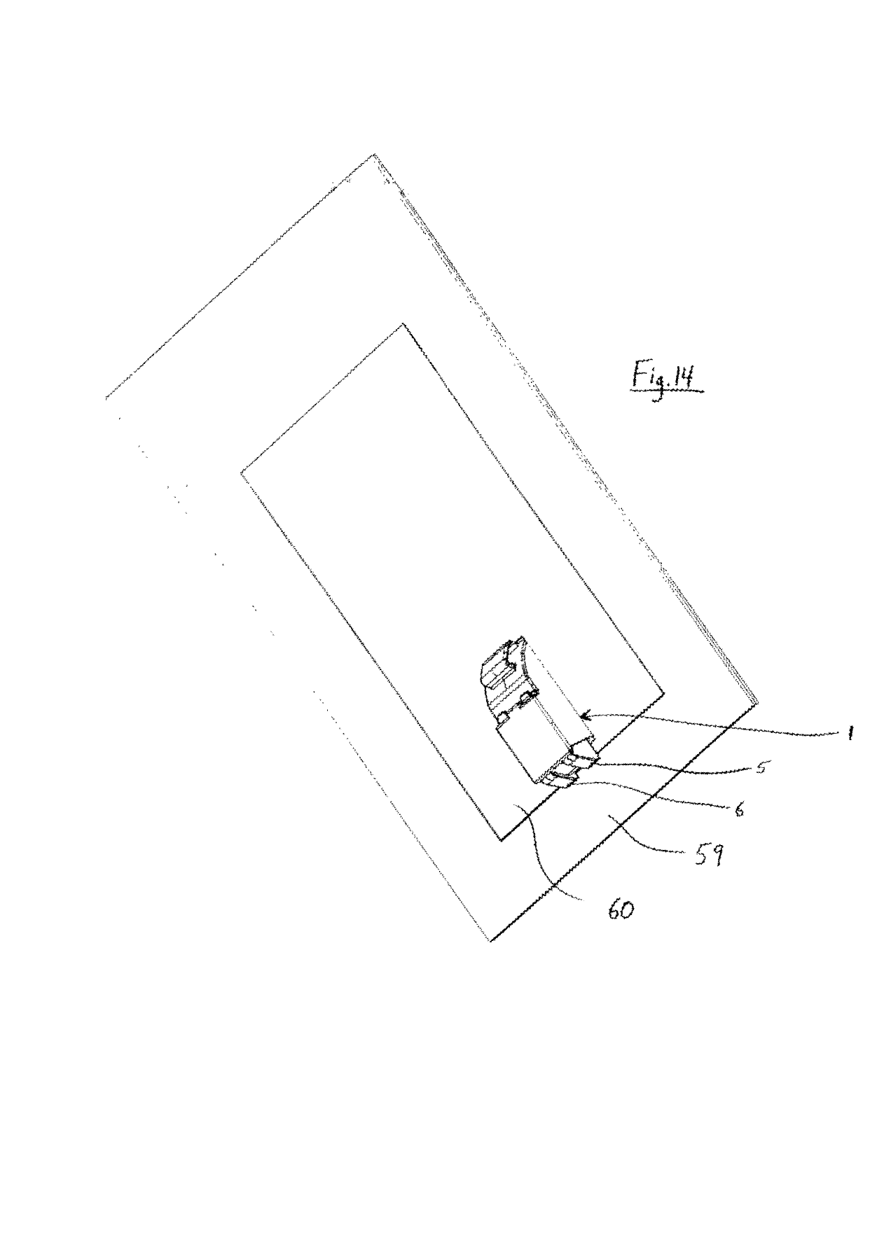

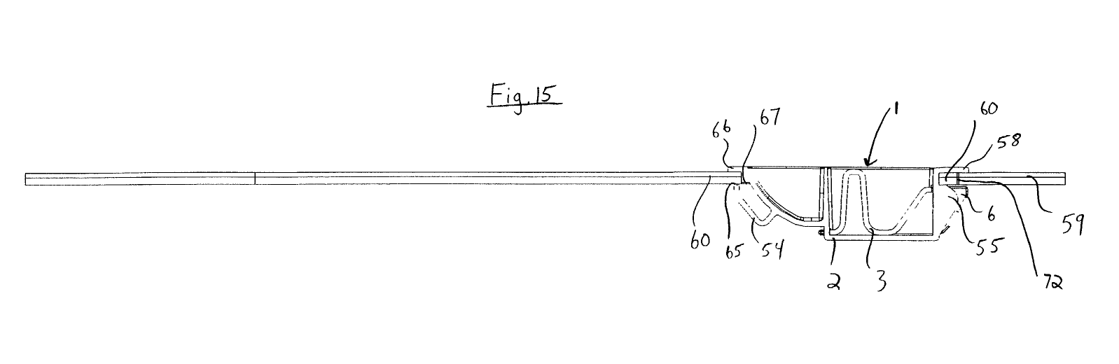

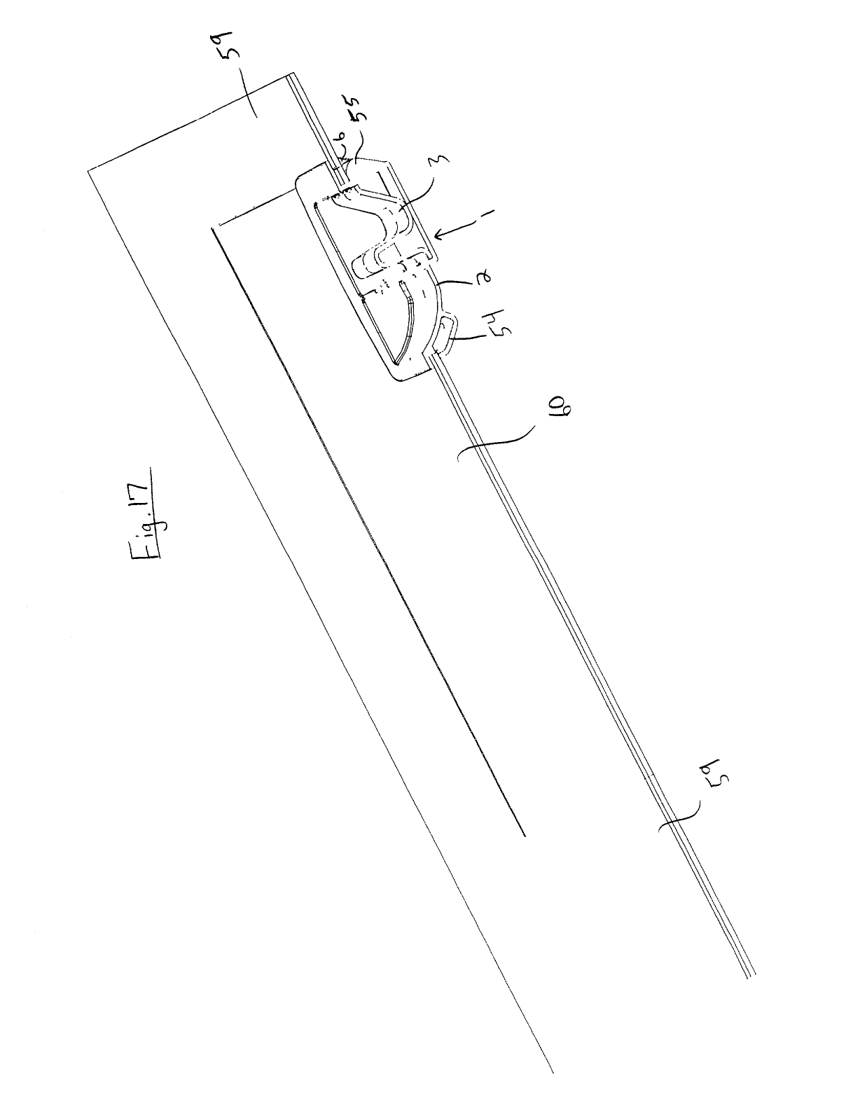

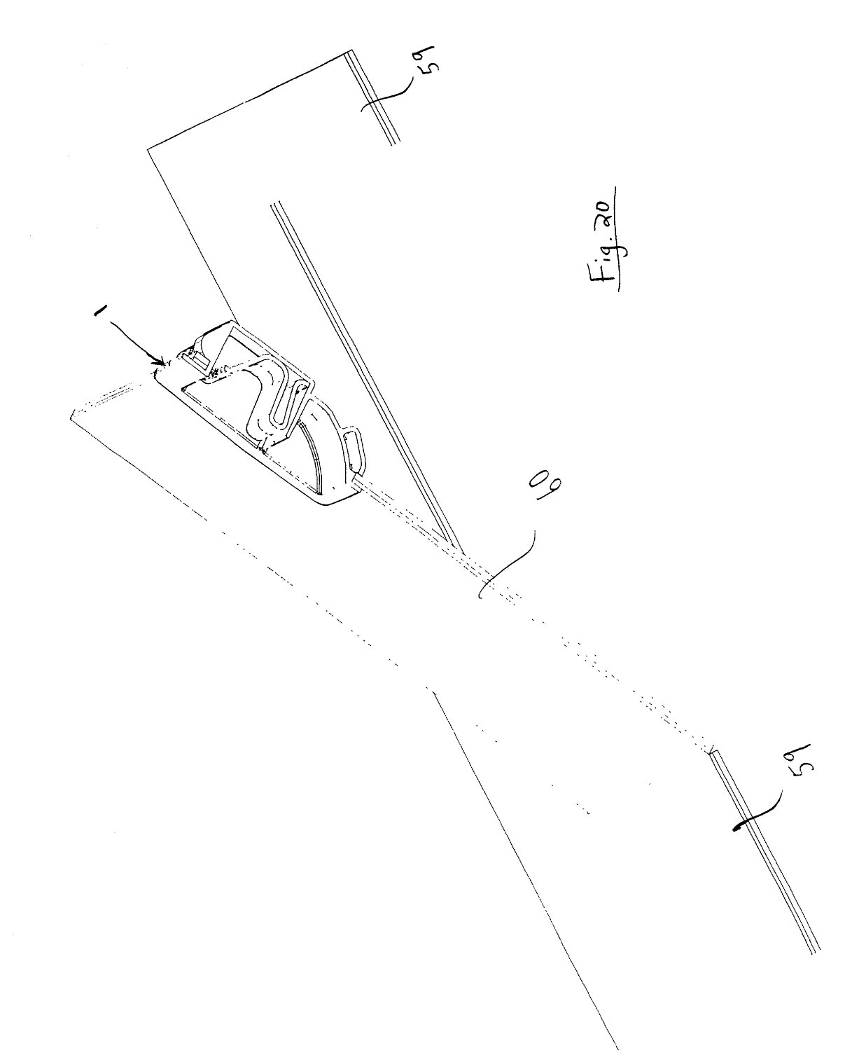

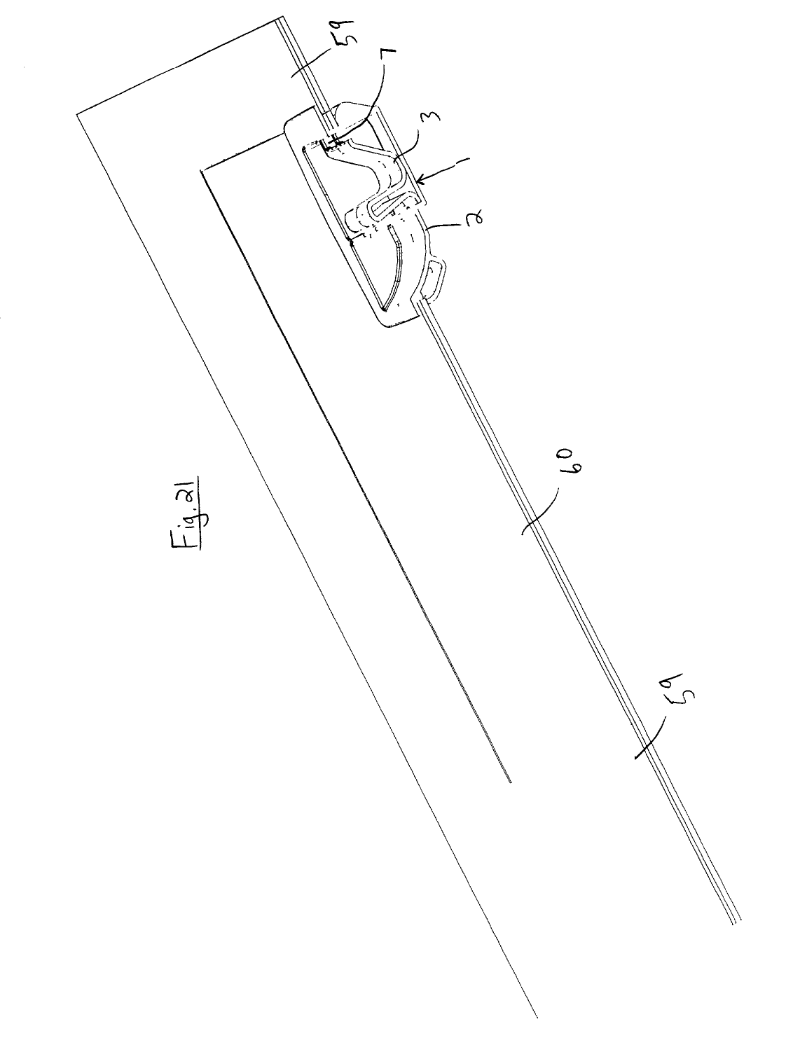

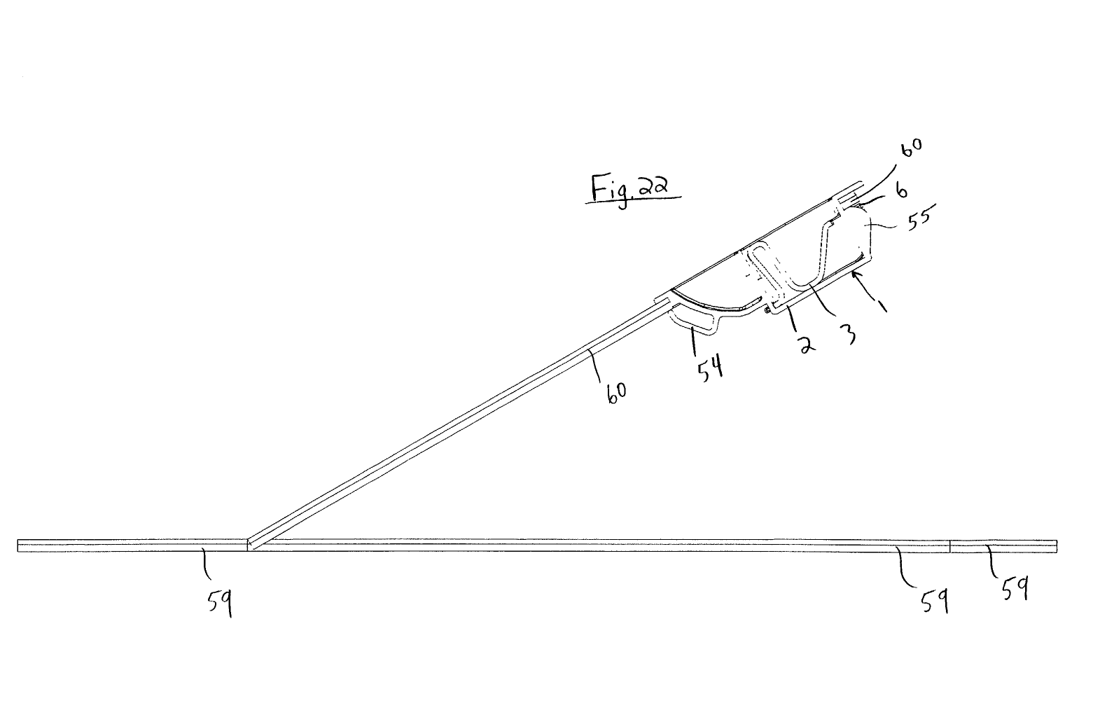

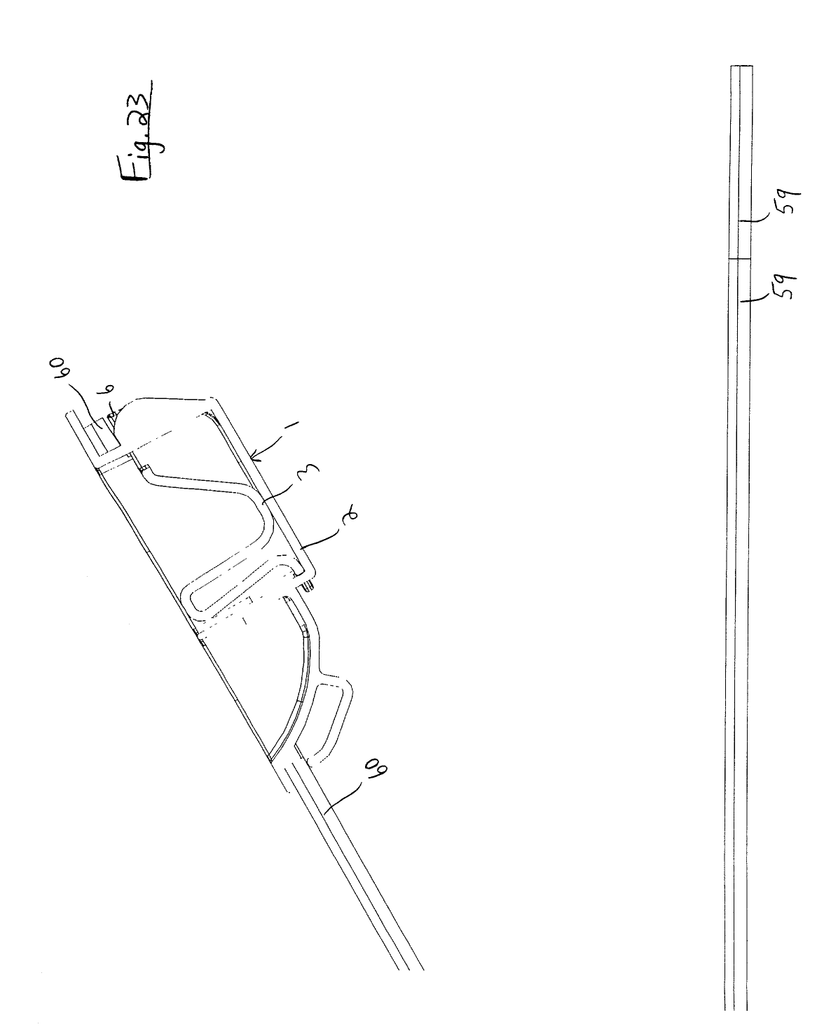

The housing wall 48 divides said housing 2 into two compartments, wherein one of the compartments is the pawl recess 43, and the other compartment is the actuation recess 44. The pawl recess 43 is adapted to receive the pawl 3, wherein the actuation recess 44 is adapted to receive the means for actuating the pawl, such as the user's fingers (not shown). The bottom of said pawl recess 43 comprises the base 53, and the bottom of said actuation recess 44 comprises the curved base 61. The top surface 45 of the housing 2 is generally flat such that when said latch 1 is mounted into the assembly (shown in FIGS. 13-23), the latch 1 becomes almost flush with other parts of the assembly (such as a frame 59 and a door 60) with only a thickness in an amount equal to a thickness of front upper lip 58 and rear upper lip 66 extending from the surface of the panel 59 and the door 60.

Said housing wall 48 terminates at its bottom with said pair of catch opening holes 51, 52. Said pair of catch opening holes 51, 52 are adapted to accommodate catches 17, 18 of said pawl 3. Thus, when the pawl 3 is installed in the housing 2, said catches 17, 18 snap into position within catch opening holes 52, 51 respectively.

The housing is adapted to receive the locking portion 71 of the pawl 3 also. Whereby, the peg opening holes 49, 50 are adapted to receive the locking pegs 5, 6 respectively. The front catch 55 is positioned such to reside within space 26 of pawl 3 once the pawl 3 is installed in the housing 2. The front catch 55 comprises an upper sloped portion 56 and a lower sloped portion 57. Said front catch 55 is dimensioned and configured such that when the latch 1 is mounted into the door 60, the front catch 55 prevents said latch 1 from moving by sandwiching said door 60 in between said front catch 55 and said front upper lip 58.

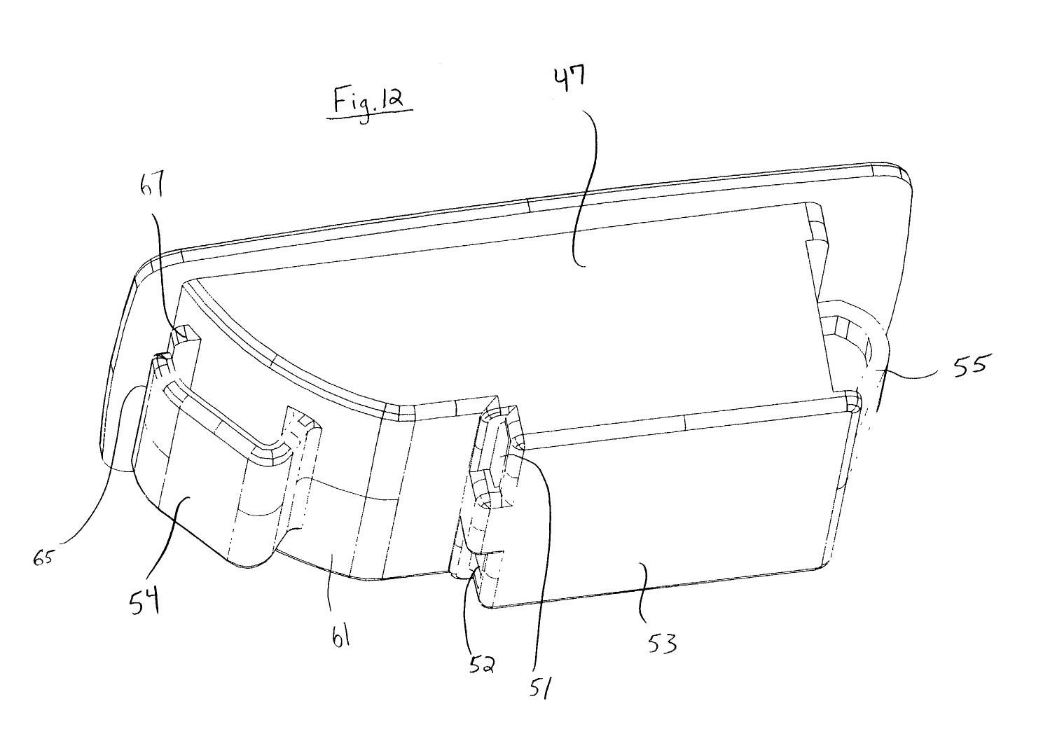

The rear catch 54 likewise keeps the latch 1 in position, and prevents the latch 1 from moving once the latch 1 is installed into the door 60. The rear catch 54, as best seen in FIG. 12, terminates at the catch stop 65, thereby the door 60 is sandwiched in between the rear upper lip 66 and the catch stop 65 of said rear catch 54. The guide 67 is included just below said rear upper lip, attached to the curved base 61 of the housing 2.

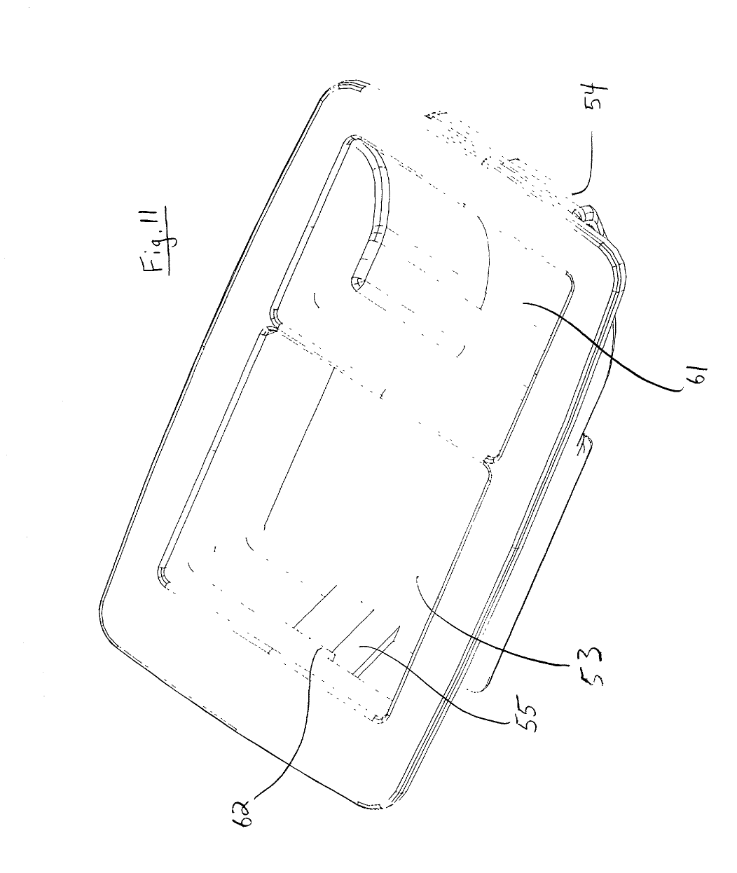

FIG. 11 most clearly shows the stop 62 extending from the top surface 45 of the housing 2. The stop 62 prevents the straight upper lip 42 of said pawl 3 from moving into the pawl recess 43, thereby limiting the lateral movement of said locking pegs 5, 6.

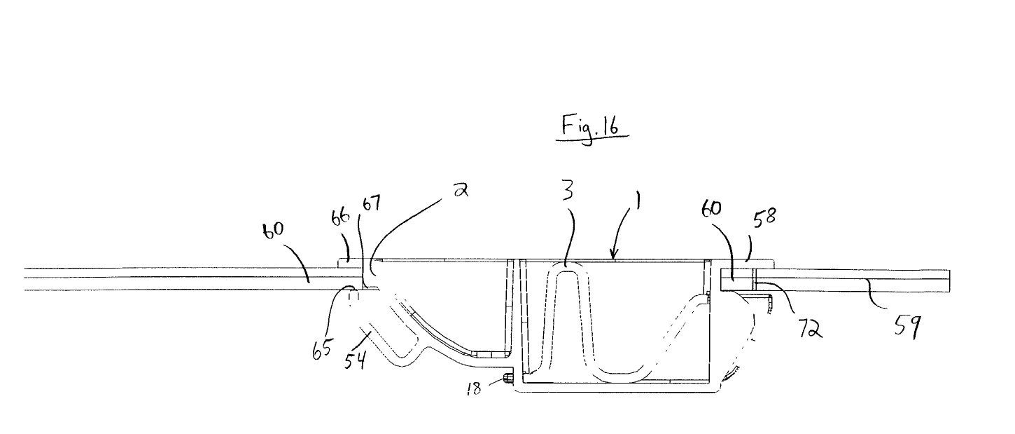

FIGS. 13-23 show the latch 1 installed in the door 60, and also show the frame 59. FIGS. 13-17 show the latch in a neutral position, whereby the locking pegs 5, 6 extend under the frame 59, thereby locking the latch 1 and preventing the door 60 from opening. FIG. 16 best shows locking peg 6 extending beyond door-frame boundary 72, wherein said boundary 72 is the demarcation line between where the frame 59 ends and the door 60 begins. Thus, once locking pegs 5,6 extend beyond this boundary 72, the latch is said to be in a neutral position, and when the door is closed, the door will be locked.

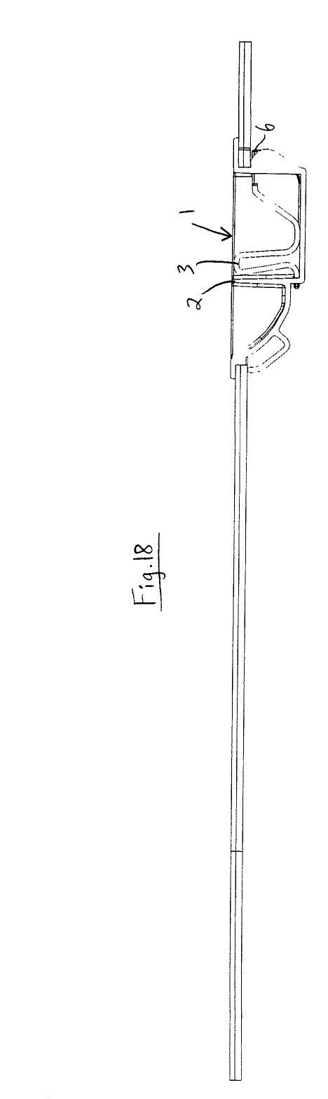

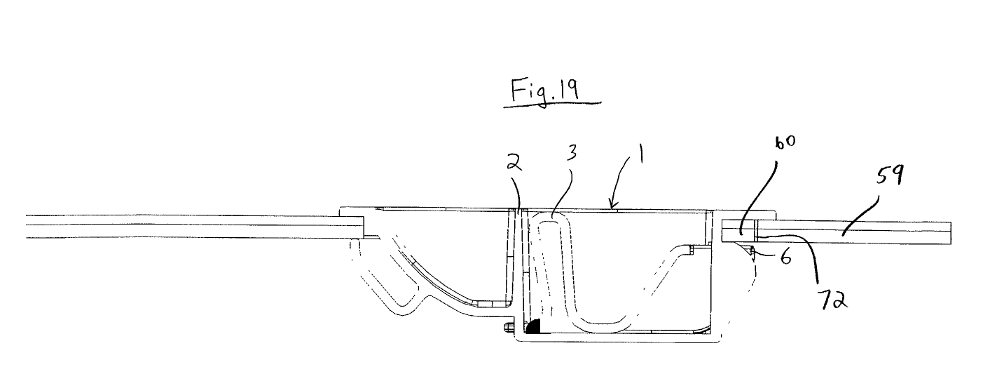

FIGS. 18-23 show the latch in an actuated position, whereby the locking pegs 5, 6 do not extend under the frame 59, thereby the latch 1 is open, and thus the door 60 may swingably open outward. FIG. 19 best shows locking peg 6 extending only under the door 60, and only up to, but not including, the door-frame boundary 72. Thus, the door 60 is capable of being opened. Once the latch 1 is actuated, and the door 60 is opened, then the user may release the pawl, such that it returns to its neutral position, whereby the locking pegs 5, 6 extend to their fullest lateral positions.

When the user wishes to close the door, then he or she does not have to actuate the latch 1. Rather the user may simply slam the latch down, wherein the front ramped walls 22, 23 of the locking pegs 5, 6 will allow the door 60 to close. At the point of contact when the latch is being slammed shut (door 60 is being slammed shut), the frame 59 at the door-frame boundary 72 will contact the front ramped walls 22, 23, causing the locking pegs 5, 6 of the pawl 3 to move laterally into a position of actuation, thereby causing the living spring portion 4 to compress, and allowing the locking pegs 5, 6 to clear the frame 59. Once the locking pegs 5, 6 clear the frame 59, and the door 60 is closed, the locking pegs 5, 6 snap back into neutral position, whereby locking pegs 5, 6 extend under the frame 59, past the door-frame boundary 72. Thus, the living spring portion 4 returns to its neutral, non-compressed position. The front upper lip 58 extends beyond the door-frame boundary 72 and over the top of the frame 59, thereby serving to prevent inward movement of the door 60 beneath the frame 59.

These and other advantages of the present invention will be understood upon a reading of the Summary of the Invention, the Brief Description of the Drawing Figures and the Detailed Description of the Preferred Embodiment. Other modifications may be made consistent with the spirit and scope of the invention described herein.

We claim:

1. A side panel latch comprising:
a) a pawl member having a locking means for engagement and disengagement with a panel and a biasing means for biasing said locking means engagement and disengagement with a panel; and
b) a dual compartment housing having a lipped top surface divided into a first compartment for engagement of said pawl member and a second compartment for accommodating the actuation means of a user.

2. The side panel latch of claim 1, wherein said first compartment of said dual compartment housing comprises a first side of a partition wall, a front catch defining a pair of openings through the front of said housing, a pair of side walls and a floor, wherein said second compartment comprises a second side of said partition wall, a sloped back wall having an interior and exterior side, a pair of side walls and a floor.

3. The said panel latch of claim 2, wherein said exterior sloped back wall has a rear projection having a first end attached to said sloped back wall and second end which extends upward, wherein a panel is trapped between said lipped top surface and said second end of said rear projection tip when installed.

4. The side panel latch of claim 1 or 3, wherein said locking means of said pawl member comprises a pair of locking pegs for retaining said latch in the closed position.

5. The side panel latch of claim 4, wherein said locking pegs comprise a front ramped wall having a curved bottom portion and a diagonal straight top portion.

6. The side panel latch of claim 5, wherein said locking pegs comprise a top wall having a indentation.

7. The side panel latch of claim 4, wherein said locking means define a space there between and are connected by a sloped inner wall.

8. The side panel latch of claim 7, wherein said sloped inner wall has a straight lip portion extending there from in the same direction as said locking pegs.

9. The side panel latch of claim 8, wherein said sloped inner wall is attached to a said biasing means.

10. The side panel latch of claim 2 or 9, wherein said biasing means is substantially u-shaped having a first wall and a second wall.

11. The side panel latch of claim 10, wherein said first wall of said biasing means has a first end attached to said locking means and said second wall of said biasing means has a second end which has a pair of tabs.

12. The said panel latch of claim 11, wherein said first compartment further comprises an extension wall between said partition wall and said floor.

13. The said panel latch of claim 12, wherein said extension wall is substantially centered between said side walls of said first compartment thereby defining a pair of openings.

14. The said panel latch of claim 13, wherein said tabs of said pawl members traverse said openings of said extension wall to secure said pawl member within said housing.
